(19) United States
(12) Patent Application Publication
(10) Pub. No.: US 2003/0202031 A1
(43) Pub. Date: Oct. 30, 2003

(54) Recording head unit

(76) Inventor: Hirotake S Nakamura, Aichi-ken (JP)

Correspondence Address: PATENT LEGAL STAFF, EASTMAN KODAK COMPANY, 343 STATE STREET, ROCHESTER, NY, 14650-2201, US

(21) Appl. No.: 10/312,182

(22) PCT Filed: Apr. 26, 2002
(86) PCT No.: PCT/JP02/04273

(51) Int. Cl. B41J 2/015

(52) U.S. Cl. 347/20

(57) ABSTRACT

A recording head unit is offered, which can easily adjust the recording heads (13, 14) to be at the correct angle relative to the scan direction of the carriage (10).

The base plate (12) supports a recording head by holding it through, and can turn around the pin (19). On the position adjusting wedge (22), the screw (23) that rotates into the screw hole provided on the top face of the bottom plate (10a) through the position adjusting wedge is provided. By means of the screwing operation of this screw, the base plate moves forward and backward relative to the bottom plate of the carriage; thereby, the position of the base plate is adjusted relative to the carriage. On the wedge, the inclined face (22a) that presses the base plate in a direction apart from the wedge is provided. Therefore, by fastening the screw, the contact part (12a) of the base plate is pressed by the position adjusting wedge corresponding to the degree of fastening, and the base plate is turned around the pin (19) as the center of rotation. Thereby, the position of the base plate relative to the carriage is adjusted.

### TECHNICAL AREA

The present invention pertains to a recording head unit. In detail, it pertains to a recording head unit wherein a recording head is mounted on a carriage and moves relative to a recording medium to make records.

### BACKGROUND TECHNOLOGY

In the prior art, as a recording device to record on a recording medium such as paper, for instance, ink jet printers are well-known. This ink jet printer is formed such that a basepart equipped with a recording head is mounted on a carriage; the carriage is reciprocally moved in parallel to a platen that feeds the recording medium to perform recording. On this ink jet printer, based on the premise that the row of nozzles of the recording head is located at a right angle or at a predetermined angle with respect to the scan direction of the carriage, the jet timing from each nozzle is determined. If the angle of the row of the nozzles is displaced, accurate printing cannot be made; it is thus necessary to correctly arrange the row of nozzles in relation to the scan direction. In general, one or more recording heads are installed on a case or a base; and the case or the base is installed on a carriage in a freely detachable manner.

However, an error is made when a recording head is installed on a case or a base; and furthermore, another error occurs when the case or the baseis/are installed on a carriage. Therefore, high precision and a large number of steps for adjustment were needed to install the parts.

### DISCLOSURE OF THE INVENTION

The present invention was made to solve the aforementioned problems. The objective is to offer a recording head unit wherein a recording head fixed to a base can be easily adjusted so as to have a correct angle with respect to the relative movement direction with the recording medium.

To realize the aforementioned objective, the recording head unit according to the present invention consists of a recording head that records on a recording medium; a base to which said recording head is fixed; and a carriage on which the aforementioned base is mounted, which moves relative to the main scan direction of recording and the aforementioned recording medium. The aforementioned carriage consists of a part that axially supports the aforementioned base in such a manner that it can freely turn,as well as an adjusting means consisting of both a means that energizes the aforementioned base, to turn in a certain direction with said axial support part as the fulcrum, and a face that presses the aforementioned base to turn in a direction opposite to the aforementioned certain direction, which continuously adjusts the position of the aforementioned base throughout the range of adjustable turning with respect to the aforementioned axial support part. The aforementioned baseconsists of an axially supported part that is in contact with the aforementioned axial support and a part that is in contact with the pressing face.

In a recording head unit with this configuration, the axial support part provided on a carriage axially supports the base in such a manner that it can freely turn; the energizing means energizes the base to turn into a certain direction using said axial support part as the fulcrum; and the adjusting means presses the contact part of the base so as to turn in a direction opposite to the other direction, and thereby adjusts the base to any turning position around the axial support part. Therefore, the base to which the recording head is fixed can be easily aligned with respect to the direction of movement relative to the recording medium.

Further, on the aforementioned recording head unit, the aforementioned adjusting means is a wedge fixed with a screw to the aforementioned carriage. On said wedge, as the aforementioned pressing face, an inclined face is provided, which presses the aforementioned base to turn into a direction opposite to the aforementioned certain direction by moving forward or backward relative to the aforementioned carriage by way of the screwing operation of the aforementioned screw.

On the recording head unit in this configuration, the inclined face of the wedge that moves forward or backward relative to the carriage by way of the screwing operation of the screw presses the base so as to turn in a direction opposite to the certain direction. Therefore, through a simple screwing operation, the base can be easily aligned relative to the carriage.

Furthermore, on the aforementioned recording head unit, the aforementioned base is formed by pressing a metal plate; on the base, a part that will be in contact with the inclined face of the wedge is provided,with said contact part being characteristically formed into an arc as an edge by pressing.

On the recording head unit in this configuration, the base is formed by pressing a metal plate; a part that will be in contact with the inclined face of the wedge is provided on the base; and said contact part is formed into an arc as an edge by pressing [Repeated text]. Therefore, the contact part can be smoothly in contact with the arc-shaped edge; thus, the base can be smoothly aligned relative to the carriage.

The present invention furthermore offers a recording head position-adjusting means consisting of a step of adjusting the position of the aforementioned base relative to the aforementioned carriage by adjusting the position of the aforementioned pressing face in the aforementioned direction of turning by manipulating the aforementioned adjusting means on the recording head unit: The recording head unit consists of a recording head that records on a recording medium; a base to which said recording head is fixed, and a carriage on which the aforementioned base is mounted, which moves relative to the main scan direction of recording and the aforementioned recording medium. The aforementioned carriage consists of an axial support part that axially supports the aforementioned base in such a manner that it can freely turn,as well as an adjusting means consisting of both an energizing means that energizes the aforementioned base to turn in a certain direction with respect to said axial support part as the fulcrum and a pressing face that presses the aforementioned base to turn in a direction opposite to the aforementioned certain direction, which continuously adjusts the position of the aforementioned base throughout the range of adjustable turning around the aforementioned axial support part. The aforementioned baseconsists of an axially supported part that is in contact with the aforementioned axial support part and a part that is in contact with the pressing face.

According to the method above, the position of the base to which the recording head is fixed can be easily adjusted relative to the carriage; thereby, the recording head and the recording medium can be easily aligned.

### BRIEF EXPLANATION OF THE DRAWINGS

FIG. 1 is an oblique view of an ink jet printer (1).

FIG. 2 is an oblique view of a carriage (10).

FIG. 3 is a right side view of a carriage(10).

FIG. 4 is a front view of a carriage (10).

FIG. 5(a) is a top view of a carriage (10); FIG. 5(b) is a cross-sectional view of a base plate (12); and FIG. 5(c) is a top view that illustrates another application form of a carriage (10).

FIG. 6 is a bottom view of a head module (11).

FIG. 7 is a front view of a chip-on-board board (24).

FIG. 8 is a back view of a chip-on-board board (24).

FIG. 9 is a right side view of a chip-on-board board (24).

FIG. 10 is a top view of a chip-on-board board (24).

FIG. 11 is an oblique view that illustrates the state of connections between an ink jet recording head (13), flexible wiring boards (15) and (16), and a chip-on-board board (24).

FIG. 12 is a top view that illustrates the state before soldering of a flexible wiring board (15).

FIG. 13 is an oblique view that illustrates the state wherein an ink jet recording head (13), and flexible wiring boards (15) and (16), are soldered.

FIG. 14 is an oblique view that illustrates the positional relationship between a flexible wiring board (16) and another flexible wiring board (17).

FIG. 15 is an oblique view that illustrates the positional relationship between a flexible wiring board (16) and another flexible wiring board (17).

FIG. 16 is an oblique view that illustrates the positional relationship between a flexible wiring board (15) and another flexible wiring board (17).

FIG. 17 is an oblique view that illustrates the positional relationship between a flexible wiring board (15) and another flexible wiring board (17).

FIG. 18 is a top view that illustrates the state wherein a sheet of double-sided tape (50) was provided to a flexible wiring board (51).

FIG. 19 is a diagram that illustrates a state wherein a flexible wiring board (51) is folded to the left and right sides.

FIG. 20 is an oblique view that illustrates a variation example of a flexible wiring board.

FIG. 21 is an oblique view that illustrates a variation example of a carriage.

### BEST FORM TO APPLY THE INVENTION

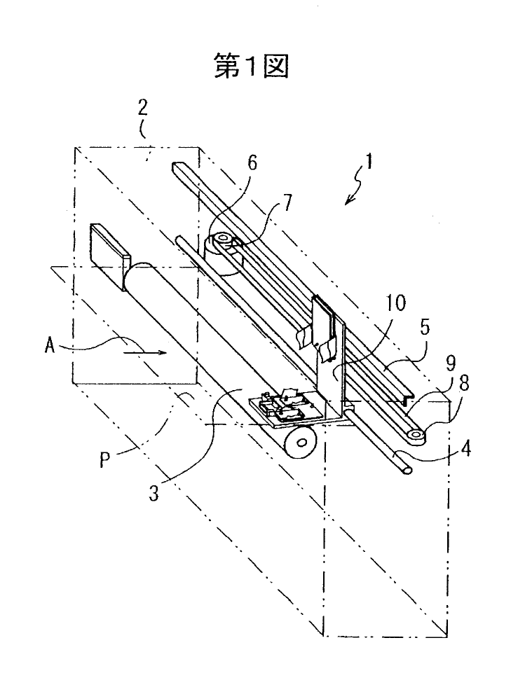

Next, an application form of the recording head unit according to the present invention will be explained with reference to the drawings. First, the internal configuration of the ink jet printer (1) that uses the recording head unit of the present invention will be explained based on FIG. 1. FIG. 1 is an oblique view illustrating the internal structure of an ink jet printer (1).

As illustrated in FIG. 1, in the body (2) of an ink jet printer (1), a platen roller (3) that carries recording paper (P) is provided; the platen roller (3) is turned, driven by an LF motor (not illustrated); and by the turning of the platen roller (3), the recording paper (P) will be carried in the direction of the arrow (A) illustrated in FIG. 1. Further, at a position opposite to the platen roller (3), a carriage (10) is provided. This carriage (10) is guided in such a manner that it can undergo reciprocal movement in parallel to the platen roller (3) by a round guide rod (4) provided in parallel to the platen roller (3) and a guide (5). The carriage (10) is fixed to a belt (9) stretched between a pulley (7) fixed to the axial part of a CR motor (6) provided at the left end in the body (2) in FIG. 1 and a pulley (8) provided at the right end in FIG. 1 in the body (2), and is reciprocally moved in parallel to the platen roller (3) by means of the driving by the CR motor (6).

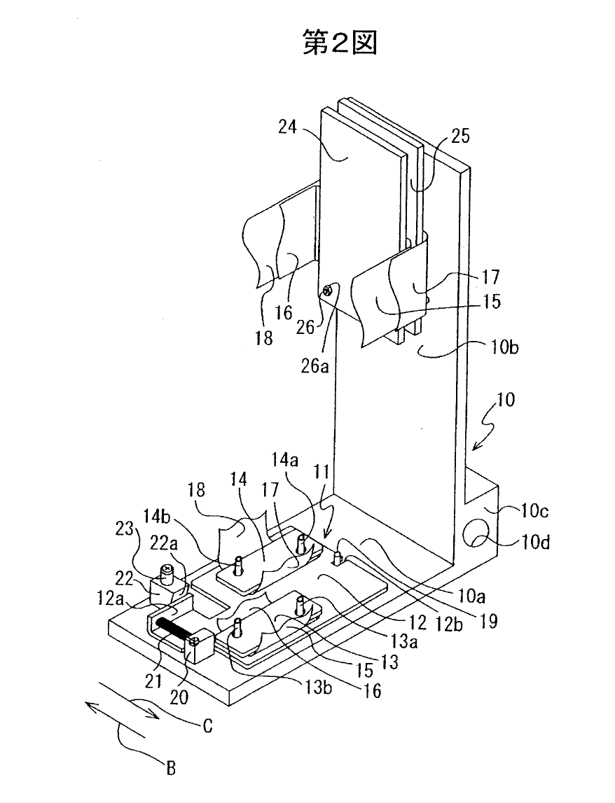

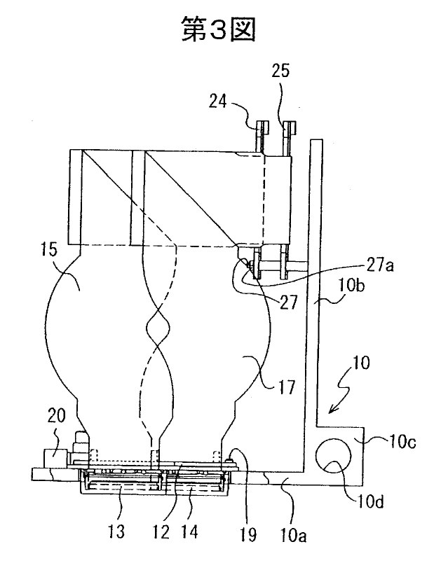

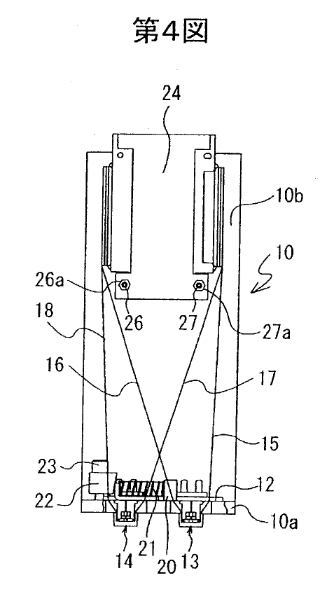

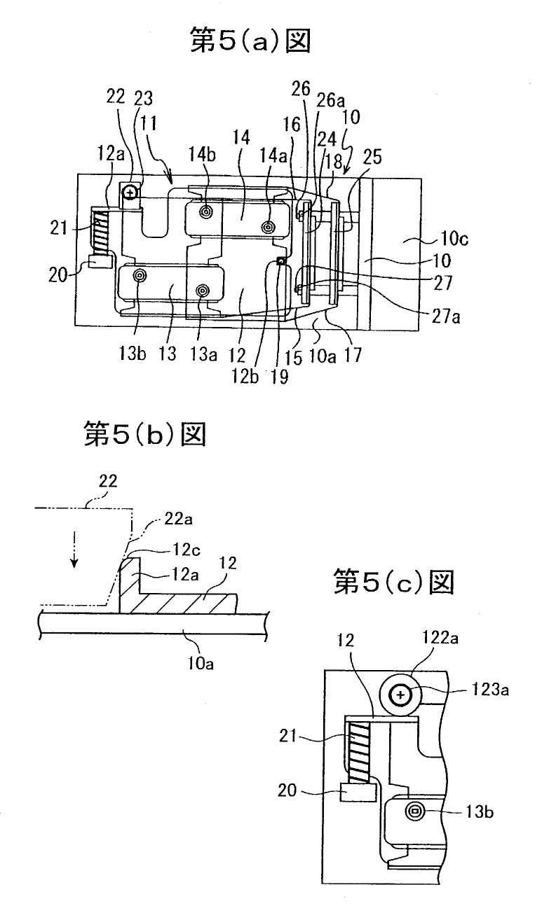

Next, referring to FIG. 2 through FIG. 6, the structures of the carriage (10) and the head module (11) will be explained. FIG. 2 illustrates an oblique view of the carriage (10); FIG. 3 illustrates a right side view of the carriage (10); FIG. 4 illustrates a front view of the carriage (10); FIG. 5(a) is a top view of the carriage (10); and FIG. 6 is a bottom view of the head module (11).

As illustrated in FIGS. 2 and 3, the carriage (10) is integrally formed from a metal such as aluminum die cast, and consists of a roughly rectangular bottom plate (10a), a roughly rectangular vertical plate (10b) provided standing perpendicularly from the end of said bottom plate (10a), and a rectangular guide part (10c), which is provided outside of the part where the vertical plate (10b) is provided, standing from the bottom plate (10a), and has a through hole (10d) provided, through which the guide rod (4) passes. Therefore, the right side face of the carriage (10) is roughly in the shape of the letter L as illustrated in FIG. 3. Further, on the back face of the vertical plate (10b), a part (not illustrated) fixed to the belt (9) is provided.

Next, as illustrated in FIG. 2 through FIG. 5(a), a roughly rectangular base plate (12), through which ink jet recording heads (13) and (14) are fixed, is provided on the top face of the bottom plate (10a) of the carriage (10). This base plate (12) is a plate material made of metal (for example, cold rolled steel) formed by pressing, and has a contact part (12a) and a notch (12b) formed on it. The base plate (12) and the inkjet recording heads (13) and (14) constitute the head module (11).

Further, on the top face of the bottom plate (10a) of the carriage (10), a pin (19), a spring holding part (20) that holds a coil spring (21) that energizes the base plate (12) in the direction of the arrow (B) illustrated in FIG. 2, and a position adjusting wedge (22) that moves the base plate (12) in the direction of the arrow (C) illustrated in FIG. 2 are provided. The base plate (12) has the notch (12b) engaged with the pin (19), and is supported around the pin (19) in such a manner that it can turn within the plane that is parallel to the moving direction of the carriage (10). On the position adjusting wedge (22), a screw (23) that is rotated into a screw hole (not illustrated), provided on the top face of the bottom plate (10a) through the position adjusting wedge (22), and an inclined face (22a) that presses the base plate (12) so as to turn it in the direction of the arrow (C) illustrated in FIG. 2 by moving forward and backward relative to the bottom plate (10a) of the carriage (10), by means of the screwing operation of the screw (23), are provided. By fastening the screw (23), corresponding to how tight it has been fastened, the contact part (12a) of the base plate (12) will be pressed by the position adjusting wedge (22); around the pin (19) as the center of rotation, the base plate (12) can be moved in the direction of the arrow (C) illustrated in FIG. 2. Further, by releasing the screw (23), depending on how much it has been released, by means of the energizing force of the coil spring (21), around the pin (19) as the center of rotation, the base plate (12) can be moved in the direction of the arrow (B) illustrated in FIG. 2. Further, the part that will be in contact with the position adjusting wedge (22) of the contact part (12a) of the base plate (12) is formed into an arc-shaped edge (12c) (FIG. 5(b)) as the outline shape of the base plate (12) formed by the mold becomes “slackened.” As mentioned above, by adjusting the turning of the head module (11), the row of nozzles of the recording heads (13) and (14) will have the accurate angle set relative to the scan direction of the carriage (10); thereby, accurate printing can be conducted. The head module (11) is preferably fixed with a screw (not illustrated) or the like at the position where it has been accurately set.

Incidentally, instead of the position adjusting wedge (22), as illustrate in FIG. 5(c), a cam (122a) may be used. In such a case, the cam (122a) is fixed to the bottom plate (10a) with a screw (123a) integrally provided at the center of rotation, and will be turned according to the degree of fastening of the screw (123a). Therefore, as the distance between the center of the cam (122a) and the contact part (12a) of the base plate (12) changes corresponding to how tight the screw (123a) is fastened, the base plate (12) will be turned around the pin (19) relative to the bottom plate (10a) of the carriage corresponding to the change in this distance.

Further, as illustrated in FIG. 2, FIG. 5(a), and FIG. 6, on the base plate (12), an ink jet recording head (13) and another ink jet recording head (14), which are roughly rectangular when observed from the top, are arranged offset in parallel with a certain space between them. The inkjet recording head (13) and the inkjet recording head (14) are composed of piezoelectric ceramic material in the same manner as an example described in Japanese Kokai Patent No. HEI 11 [1999]-286111, have multiple injection channels (not illustrated) to contain ink arranged in two rows, and have a nozzle connected to each injection channel. Further, on both side faces parallel to the rows of injection channels of each recording head, connection terminals (not illustrated) respectively connected to the driving element of each injection channel are provided in rows.

As illustrated in FIG. 6, on the bottom face of the ink jet recording head (13), two rows of nozzle rows (13c) and (13d), which inject ink, are arranged in parallel. On each of the nozzle rows (13c) and (13d), 150 nozzles are arranged in a row with the resolution of 150 dpi. The nozzle pitches of the nozzle row (13c) and the nozzle row (13d) are displaced by a half pitch. Therefore, the resolution of a single inkjet recording head (13) will be 300 dpi. Further, on the bottom fact of the ink jet recording head (14), two rows of ink injecting nozzle rows (14c) and (14d) are arranged in parallel. On each of the nozzle rows (14c) and (14d), 150 nozzles are arranged in a row with the resolution of 150 dpi. The nozzle pitches of the nozzle row (14c) and the nozzle row (14d) are displaced by a half pitch. Therefore, the resolution of a single inkjet recording head (14) will also be 300 dpi. Both recording heads (13) and (14) are arranged so as to provide the total of 600 nozzles in a direction crossing at a right angle to the moving direction of the carriage (10) as a whole head module (11).

Further, as illustrated in FIG. 2 and FIG. 5(a), on the top face of the ink jet recording head (13), ink supply ports (13a) and (13b) are provided opening on the top face of the bottom plate (10a) of the carriage, and ink will be suppliedfrom the ink tank (not illustrated). Furthermore, on the top face of the inkjet recording head (14) as well, ink supply ports (14a) and (14b) are provided in the same manner; from the ink tank (not illustrated), ink will be supplied. The chip-on-board boards (hereafter, called “COB boards”) (24) and (25) are positioned on the side of the vertical plate (10b), providing a space having the top direction of the ink supply ports (13a), (13b), (14a) and (14b) open; thereby, direct connection of an ink tank to the ink supply ports or the connection of a tube extending from an ink tank can be made easy.

As illustrated in FIG. 2 through FIG. 5(a), the COB boards (24) and (25) are driving circuit boards in the shape of a roughly rectangular platethat outputs the injection pulse, which is the driving signal to drive the ink jet recording heads (13) and (14). They are fixed to the fixed axis parts (26) and (27) on the top of the vertical plate (10b) of the carriage (10) with lock nuts (26a) and (27a).

Further, as illustrated in FIG. 2 and FIG. 4, to the connection terminal row (not illustrated) on the right side face of the ink jet recording head (13), one end of a flexible wiring board (15) is soldered; the other end on the opposite side of the aforementioned end of the flexible wiring board (15) is soldered to the right side end on the back face of the COB board (24). Furthermore, to the connection terminal row (not illustrated) on the left side face of the ink jet recording head (13), one end of a flexible wiring board (16) is soldered; the other end on the opposite side of the aforementioned end of the flexible wiring board (16) is soldered to the left side end on the back face of the COB board (24). Therefore, the flexible wiring boards (15) and (16) are provided as a pair corresponding to the connection terminal rows on both side faces of the ink jet recording head (13).

Further, to the connection terminal row (not illustrated) on the right side face of the ink jet recording head (14), one end of a flexible wiring board (17) is soldered; the other end on the opposite side of the aforementioned end of the flexible wiring board (17) is soldered to the right side end on the back face of the COB board (25). Also to the connection terminal row (not illustrated) on the left side face of the ink jet recording head (14), one end of a flexible wiring board (18) is soldered; the other end on the opposite side of the aforementioned end of the flexible wiring board (18) is soldered to the left side end on the back face of the COB board (25). Therefore, the flexible wiring boards (17) and (18) are provided as a pair corresponding to the connection terminal rows on both side faces of the ink jet recording head (14).

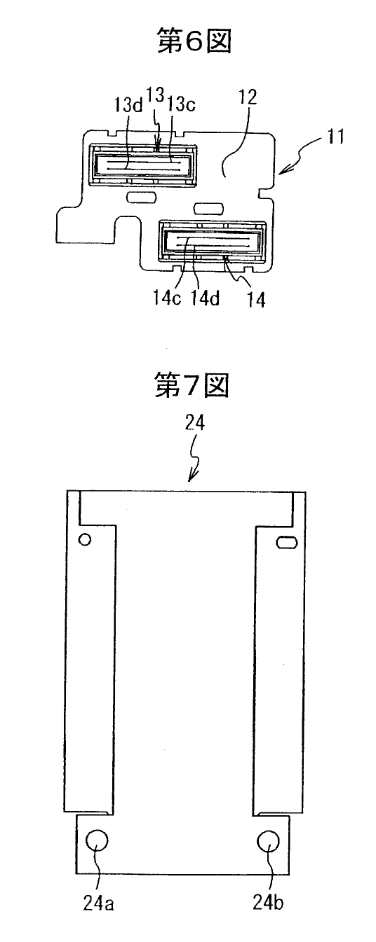

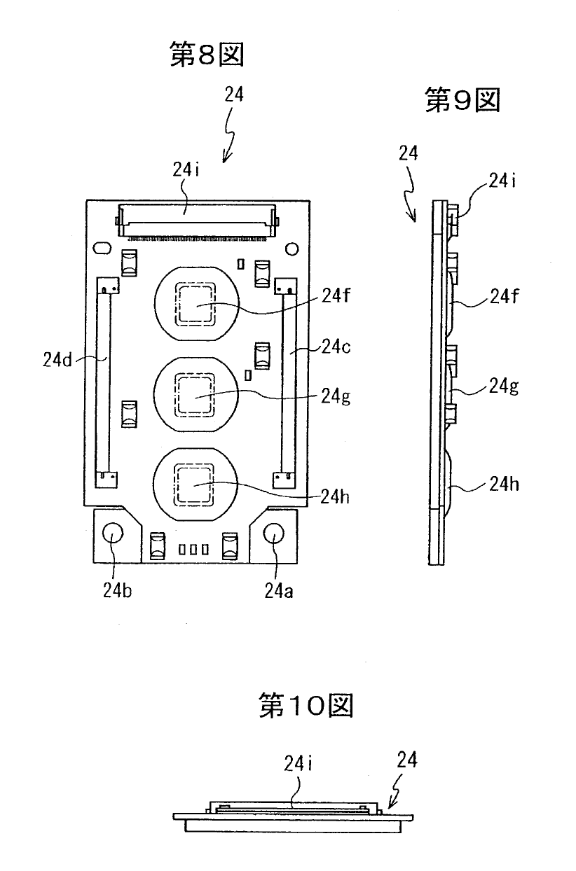

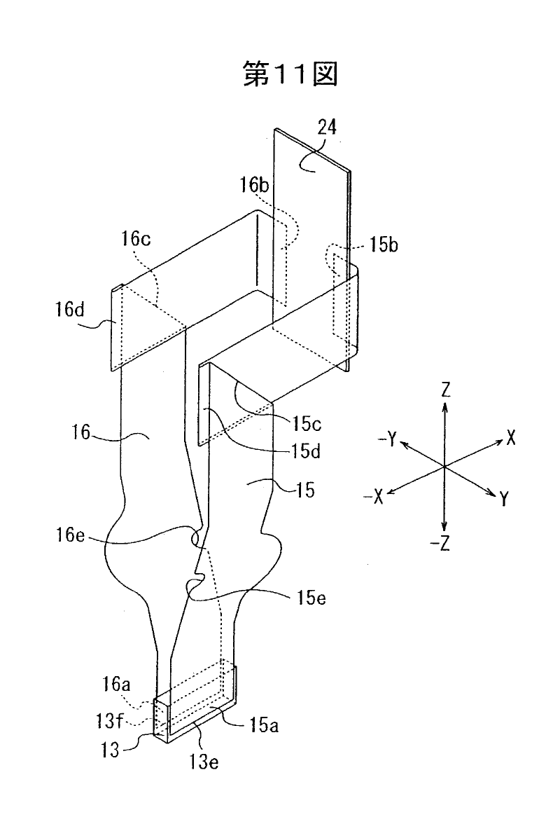

Next, referring to FIG. 7 through FIG. 10, the structure of the COB board (24) will be explained. FIG. 7 illustrates a front view of the COB board (24); FIG. 8 illustrates a back view of the COB board (24); FIG. 9 illustrates a right side view of the COB board (24); and FIG. 10 illustrates a top view of the COB board (24).

As illustrated in FIG. 7 through FIG. 10, the COB board (24) is roughly a rectangular printed wiring board; on the lower part of the COB board (24), through holes (24a) and (24b) through which fixed axis parts (26) and (27) pass are provided. Further, as illustrated in FIG. 8 and FIG. 9, driving IC chips (24f), (24g), and (24h) are provided in the middle on the back face of the COB board (24). Further, in the left side end on the back face of the COB board (24), the terminal row (24d) to which the flexible wiring board (15) is soldered is provided; in the right side end on the back face of the COB board (24), the terminal row (24c) to which the flexible wiring board (16) is soldered is provided. As illustrated in FIG. 8 through FIG. 10, in the upper end on the back face of the COB board (24), a connector (24i) into which a flexible flat cable fits (not illustrated), extending from a control circuit board (not illustrated) fixed to the body (2) outside of the carriage (10), is provided. Furthermore, on the back face of the COB board (24), multiple chip resistors and chip capacitors are provided, among others. Incidentally, the COB board (25) has the same structure.

Further, as illustrated in FIGS. 1 through FIG. 3, the COB board (24) and the COB board (25) are fixed onto the vertical board (10b) of the carriage (10) superimposed with a certain space between them; the COB board (24) and the COB board (25) are fixed onto the vertical plate (10b) of the carriage (10) having the planes (front face and back face) in parallel to the moving direction of the carriage (10) and in parallel in the direction of the gravity. The space along both of these boards (24) and (25) open upward, and preferably nothing is placed above them except the body (2). Therefore, as the planes of the COB board (24) and COB board (25) with severe heat emission from the mounted driving IC are in parallel to the moving direction of the carriage (10), they will be air-cooled by the reciprocal movement of the carriage (10). Also, as the planes (front face and back face) of the COB board (24) and COB board (25) are in parallel in the direction of gravity, the air around the COB boards (24) and (25) having a relative density that has decreased, because it was heated by the heat emitted from the COB board (24) and the COB board (25), will move upward (opposite direction in the force of gravity); thereby, the COB board (24) and the COB board (25) will be easily cooled.

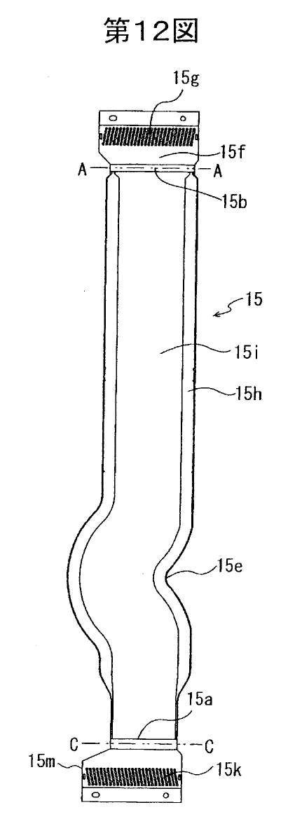

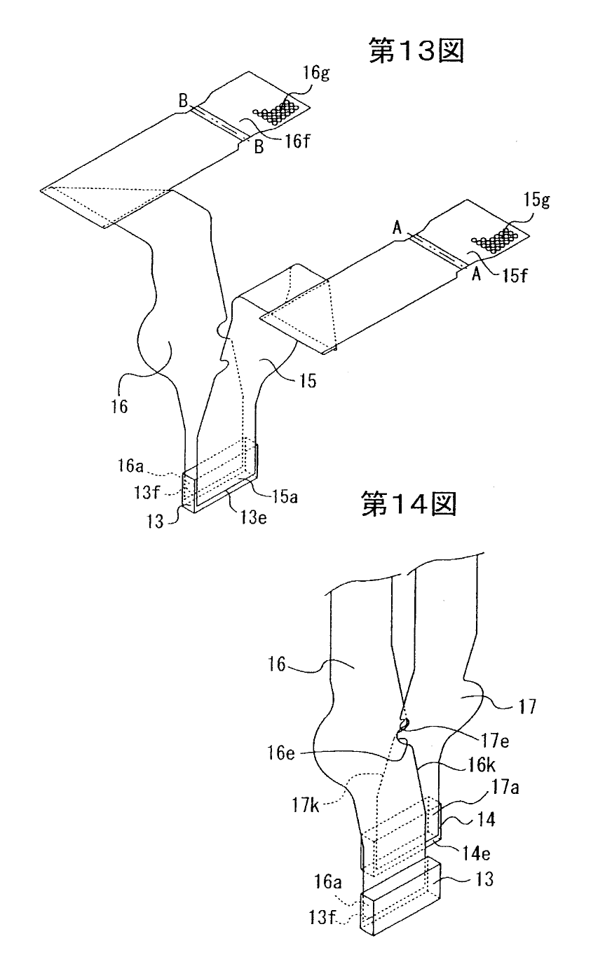

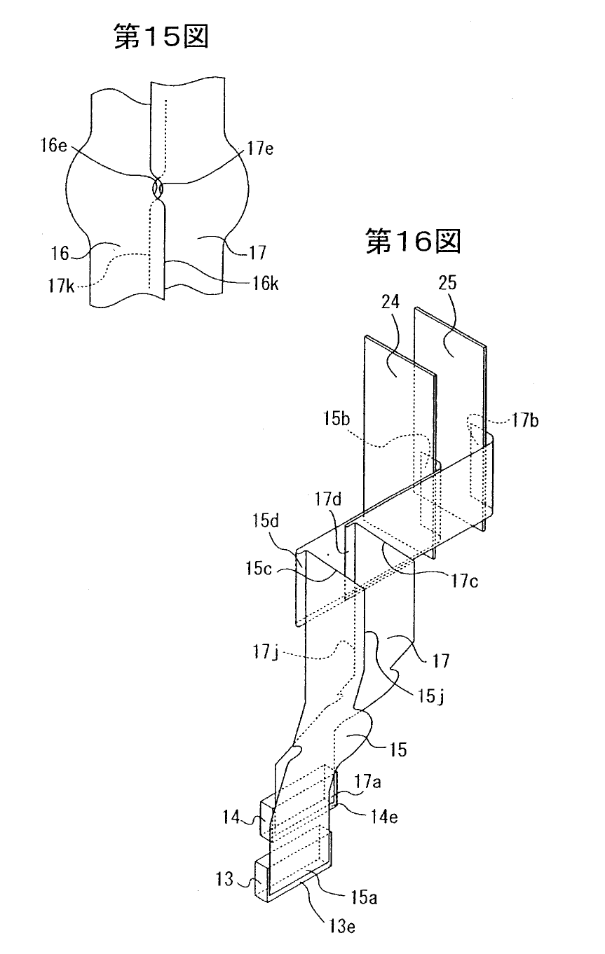

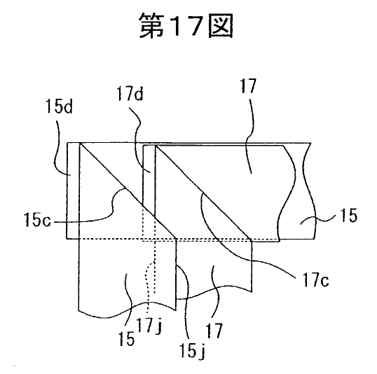

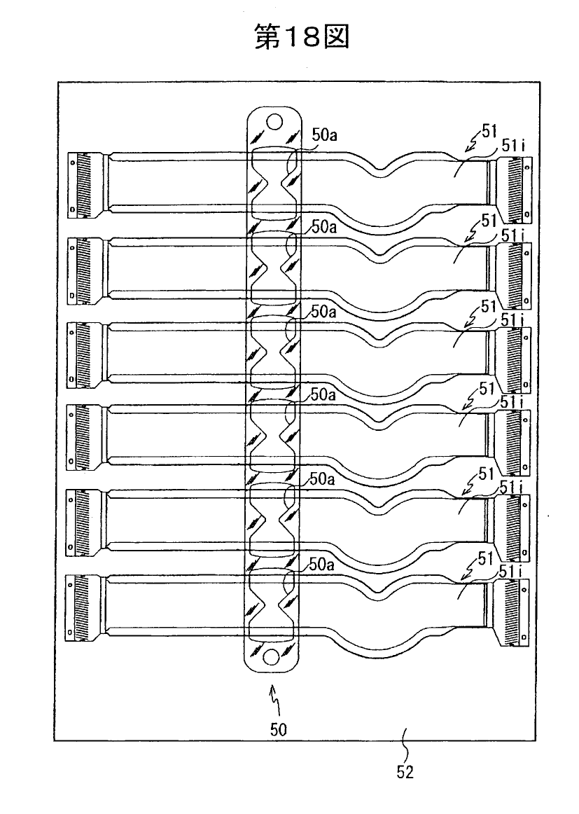

Next, referring to FIG. 11 through FIG. 17, the detailed structures of the flexible wiring boards (15)˜(18) will be explained. FIG. 11 is an oblique view illustrating how the ink jet recording head (13), flexible wiring boards (15) and (16), and COB board (24) are connected; FIG. 12 is a top view illustrating the state before soldering of the flexible wiring board (15); FIG. 13 is an oblique view illustrating the state wherein the ink jet recording head (13) and the flexible wiring boards (15) and (16) are soldered; FIGS. 14 and 15 are oblique views illustrating the positional relationship between the flexible wiring board (16) and the flexible wiring board (17); and FIGS. 16 and 17 are oblique views illustrating the positional relationship between the flexible wiring board (15) and the flexible wiring board (17).

As illustrated in FIG. 11, the flexible wiring board (15) having an end (15a) soldered to the connection terminal row (not illustrated) on the side face (13e) of the ink jet recording head (13) is installed, extending from the ink jet recording head (13) upward (in the direction of Z in FIG. 11); in the middle, it is bent back roughly at a right angle with respect to the longitudinal direction of the flexible wiring board (15) where the bent part (15c) is formed. The tip is then installed extending toward the left (in the direction of X in FIG. 11), further bent back 180 degrees to form the bent part (15d), and the tip is installed extending toward the right (in the direction of X in FIG. 11), so that the tip (15b) is soldered to the terminal row (24d) (see FIG. 8) provided on the back face of the COB board (24).

Further, as illustrated in FIG. 11, the flexible wiring board (16) having an end (16a) soldered to the connection terminal row (not illustrated) on the side face (13f) of the inkjet recording head (13) is installed, extending from the ink jet recording head (13) upward (in the direction of Z in FIG. 11); in the middle, it is bent back roughly at a right angle with respect to the longitudinal direction of the flexible wiring board (16) where the bent part (16c) is formed. The tip is then installed extending toward the left (in the direction of X in FIG. 11), further bent back 180 degrees to form the bent part (16d), and the tip is installed extending toward the right (in the direction of X in FIG. 11), so that the tip (16b) is soldered to the terminal row (24c) (see FIG. 8) provided on the back face of the COB board (24). That is, the bent parts (15c) and (15d), as well as (16c) and (16d), of both flexible wiring boards (15) and (16) are roughly mirror images. Each bent part is fixed with adhesive tape or another form of adhesive.

Because the flexible wiring board (15) has multiple circuit patterns (15i) printed only on one side of a resin plate (15h), even if the face of the circuit pattern (15i) is exposed by the bent part (15c) roughly at a right angle, the 180 degree bent part (15d) will allow the circuit pattern (15i) to be exposed on the same side. Therefore, the soldered face at one end (15a) of the flexible wiring board (15) and the soldered face at one end (16a) of the flexible wiring board (16) will be located opposite to each other, containing the ink jet recording head (13) between them, and the soldered face at the tip (15b) of the flexible wiring board (15) and the soldered part at the tip (16b) of the flexible wiring board (16) will be opposite to each other before soldering to the COB substrate (24). Incidentally, the flexible wiring boards (17) and (18) soldered to the ink jet recording head (14) and the COB substrate (25) have the same configuration as the aforementioned flexible wiring boards (15) and (16).

Next, referring to FIG. 12, the structure of the flexible wiring board (15) will be explained. As illustrated in FIG. 12, on a flexible wiring board (15), on one side of a strip sheet (15h) made of a flexible and conductive resin such as a polyimide, multiple circuit patterns (15i) comprised of copper foil conductors are formed; further, an insulating film that covers the circuit patterns (15i) is formed. At the parts (15f) and (15m), which further extend from the parts where the circuit patterns (15i) are exposed at both ends (15a) and (15b) in the longitudinal direction of the flexible wiring board (15), multiple checking electrode parts (15k) and (15g) connected to each circuit pattern (15i) are respectively formed. After each flexible wiring board (15) is manufactured, voltage is impressed onto the checking electrode parts (15k) and (15g) at both ends of each single unit; thereby, each of the multiple circuit patterns (15i) is tested for conductivity/non-conductivity.

The flexible wiring boards (16)˜(18) have the same shape and the same wiring as the aforementioned flexible wiring board (15),except only the folding directions are different for the flexible wiring boards (15) and (16), and (17) and (18). Therefore, preparing one kind of flexible wiring board is sufficient. On each flexible wiring board (15 will be explained), the extended part 15m is cut off with a C-C line leaving a part of the area where the circuit patterns (15i) are exposed on one end (15a); the circuit patterns (15i) are soldered to the connection terminal of the recording head (13).

Next, testing of the flexible wiring board (15) and ink jet recording head (13) using a flexible wiring board pattern checking electrode part (15f) will be explained. As mentioned above, in a state in which the flexible wiring boards (15) and (16) are soldered to both sides (13e) and (13f) of the ink jet recording head (13), the electrode terminal (15g) on the flexible wiring board pattern-checking electrode part (15f) of the flexible wiring board (15) and the electrode terminal (16g) on the flexible wiring board pattern-checking electrode part (16f) of the flexible wiring board (16) are connected to a testing device (not illustrated); the soldering state of the flexible wiring boards (15) and (16) to the ink jet recording head (13), among others, is tested. Further, inputting a driving pulse signal, the driving state of the ink jet recording head (13) is tested. When the test results are good, the flexible wiring boards (15) and (16) are respectively cut off with an A-A line and a B-B line; respective circuit patterns at the tip of the flexible wiring boards (15) and (16) are soldered corresponding to the terminal rows (24c) and (24d) of the COB board (24). Incidentally, the flexible wiring boards (17) and (18) and the ink jet recording head (14) are tested in the same manner as above.

Next, referring to FIGS. 3, 4, 12, 14,and 15, the structure and action of the curved parts provided on the flexible wiring boards (15)˜(18) will be explained. On the flexible wiring board (15), as illustrated in FIG. 12, a curved part (15e), which is bent so as to be depressed relative to the width direction that crosses at a right angle to the longitudinal direction of the flexible wiring board (15) is formed. Incidentally, other curved parts in the same shape as the curved part (15e) are respectively provided on the flexible wiring boards (16)˜(18).

As illustrated in FIG. 4 and FIG. 14, this curved part is provided to prevent the side end of the flexible wiring board (16) and the side end of the flexible wiring board (17), which cross each other, from interfering with each other. Specifically, as illustrated in FIG. 4, the flexible wiring board (16) connected to the left side face (in FIG. 4) of the ink jet recording head (13) is provided, extending toward the direction of the left side face (in FIG. 4) of the COB board (24); the flexible wiring board (17) connected to the right side face (in FIG. 4) of the ink jet recording head (14) is provided, extending toward the direction of the right side face (in FIG. 4) of the COB board (25) (see FIG. 2) provided on the back face side of the COB board (24). While the recording heads (13) and (14) may be offset in a direction orthogonal to the moving direction of the carriage (10), when observed from the moving direction of the carriage (10), the nozzle space between the adjacent ends of both of the recording heads must be the same as the other nozzle spaces. Meanwhile, when the space of the conductors in the circuit patterns of each flexible wiring board is set approximately the same or larger than the nozzle space, because the width of the resin plate (15h) is wider than the width of the circuit patterns, the side end of the flexible wiring board (16) and the side end of the flexible wiring board (17) will interfere with each other.

Here, as illustrated in FIG. 14 and FIG. 15, at the side ends (16k) and (17k) where the flexible wiring board (16) and the flexible wiring board (17) face each other, since the depressions of the curved part (16e) and the curved part (17e) face each other, the flexible wiring boards (16) and (17) can replace the left and right positions without interference between the side end (16k) of the flexible wiring board (16) and the side end (17k) of the flexible wiring board (17), which cross each other; thereby, breakage and disconnection can be prevented.

Next, referring to FIG. 16 and FIG. 17, the structure wherein the bent part (17d) of the flexible wiring board (17) is contained within the bent part (15d) of the flexible wiring board (15) will be explained. As illustrated in FIG. 16, the flexible wiring board (15) having one end (15a) soldered to the side face (13e) of the ink jet recording head (13) has the tip (15b) soldered to the right side end (in FIG. 16) on the back face of the COB board (24). Further, the flexible wiring board (17) having one end (17a) soldered to the side face (14e) of the inkjet recording head (14) has the tip (17b) soldered to the right side end (in FIG. 16) on the back face of the COB board (25).

Here, as the soldering position of each flexible wiring board is at the same height on the COB board (24) and the COB board (25), relative to the flexible wiring board (15) from the bent part (15d) toward the COB board (24), the flexible wiring board (17) from the bent part (17d) toward the COB board (25) will be superposed outside (that is, the right side in the figure). Further, relative to the flexible wiring board (15) from the bent part (15c) toward the side of the ink jet recording head (13), the flexible wiring board (17) from the bent part (17c) toward the side of the ink jet recording head (14) is located on the left side in the figure. Therefore, although both flexible wiring boards must inter-replace left and the right positions in the middle, when both recording heads (13) and (14) are observed from the side, the widths of both flexible wiring boards are in an overlapping relationship for the same reason as mentioned earlier, and they will interfere with each other; thus, the flexible wiring boards (15) and (17) will be in contact with each other and be broken or disconnected.

In the present application form, to protect the side end (15j) of the flexible wiring board (15) and the side end (17j) of the flexible wiring board (17), as illustrated in FIG. 16 and FIG. 17, the bent part (17d) of the flexible wiring board (17) will be contained in the bent part (15d) of the flexible wiring board (15). In this manner, both flexible wiring boards (15) and (17) can have the left and the right sides replaced without having their side ends interfering with each other; besides, both can be prevented from inconsistently and freely swinging. Further, the flexible wiring boards (16) and (18) are configured in the same manner.

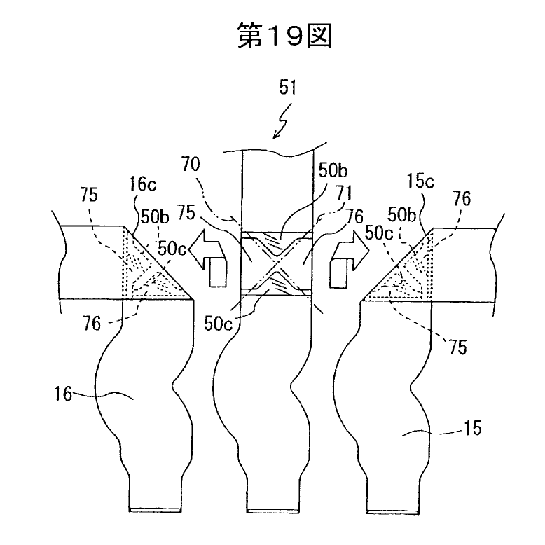

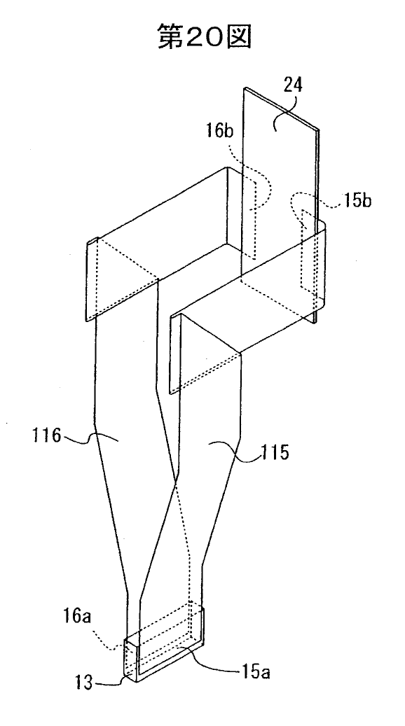

Next, referring to FIG. 18 and FIG. 19, the adhesive structure of the bent parts (15c) and (16c) of the flexible wiring boards (15) and (16) will be explained. FIG. 18 is a top view illustrating the state of the board sheet (52) before multiple flexible wiring boards (51) are die-cut, wherein a sheet-formed double-sided tape (50) is provided; FIG. 19 illustrates a state wherein the die-cut flexible wiring board (51) is bent in respective left and right directions and taped with the double-sided tapes (50b) and (50c).

As illustrated in FIG. 18, on the board sheet (52) composed of a resin such as a polyimide having flexibility and insulating characteristics, multiple flexible wiring boards (51), which are strip-formed sheets, are formed; thus, multiple circuit patterns (51i) comprised of copper foil conductors are formed in predetermined intervals; further an insulating film that covers the aforementioned circuit patterns (51i) is formed. On the multiple flexible wiring boards (51) formed, double-sided tape (50) in the form of a roughly rectangular sheet is adhered. Specifically, the sheets of double sided tape (50) are adhered so that the longitudinal direction will be approximately in parallel to the board width direction of each flexible wiring board (51) (so as to be orthogonal to the longitudinal direction of each flexible wiring board (51)). This is to eliminate the problem of taping the double-sided tape (50) individually to the flexible wiring board (51), and to integrally die-cut the multiple flexible wiring boards with the double-sided tape (50) all at once.

Furthermore, the sheets of double-sided tape (50) have cut-off part (50a), which is cut into the shape of a hand drum, wherein the width expands from the approximate center in the plate width direction toward the edges on each flexible wiring board (51), and is taped onto the flexible wiring board (51) so as to contain both the bending line where each flexible wiring board is bent and the line that is orthogonal to said line in this hand-drum-shaped notched part (50a). Therefore, after die-cutting each flexible wiring board (51) using an edged [edging] tool (not illustrated), as illustrated in FIG. 19, of the four areas in the approximate shape of a right isosceles triangle partitioned with the bending line (70) or (71), and the line (71) or (70) that crosses at the right angle with the bending line, the double-sided tape (50b) and the double-sided tape (50c) respectively in the shape of approximate right isosceles triangle will remain in a pair of areas of flexible wiring board (51) in the longitudinal direction.

When the flexible wiring board (51) is bent forward on the right side in FIG. 19 at the bending line (71), the double-sided tape (50) will adhere to the adhesive face (76) opposite to the double-sided tape (50b); the double-sided tape (50c) will adhere to the adhesive face (75) opposite to the double-sided tape (50c), and an inflexible wiring board (15) will be formed. Further, when it is bent forward on the left side in FIG. 19 at the bending line (70), the double-sided tape (50b) will adhere to the adhesive face (75) opposite to the double-sided tape (Sob); the double-sided tape (50c) will adhere to the adhesive face opposite to the double-sided tape (50c), and an inflexible wiring board (16) will be formed. Therefore, the flexible wiring board (51) will have the double-sided tape (50b) or (50c) respectively adhere to the adhesive face (75) or the adhesive face (76), in whichever direction it is bent, i.e., left or right; consequently, the bent parts (15c) and (16c) will be securely bonded.

Further, the double-sided tape (50b) and (50c) is formed from the remaining part of a sheet-formed double-sided tape (SO) after cutting out the shapes of hand-drums; thus,since no double-sided tape will be placed on the bending lines (70) and (71) of the flexible wiring board (51) (that is, the double-sided tape is provided only in the vicinity of the bending lines with a space in between), the bending line (70) or the bending line (71) can be securely attached. Further, in the adhesive structure of the bent parts (15c) and (16c), in the application form of the present invention, a method has been explained in which double-sided tape is used for adhesion. Needless to mention, adhesion may be materialized in other methods. For instance, adhesives such as a silicone adhesive, photo-hardening adhesive, or epoxy resin adhesive may be used. Also, instead of leaving the double-sided tape in the longitudinal direction of the flexible wiring board (51), the double-sided tape may be left in the width direction of the board. Further, the aforementioned adhesive structure can be used not only for the flexible wiring boards (15) and (16) but also in the same manner for the flexible wiring boards (17) and (18).

As explained above, according to the ink jet printer (1) in the form of the present application, by bending the flexible wiring board (15) in a shape and wiring such as that illustrated in FIG. 12 at a right angle and 180 degrees, it can be used as two types of flexible wiring boards (15)˜(18) in symmetrical shapes to the left and right. Further, because the superimposition of the curved part and bent parts is provided on the flexible wiring boards (15)˜(18), breakage and disconnection of the flexible wiring boards (15)˜(18) can be prevented. Further, heat radiation of the COB boards (24) and (25) can also be sufficiently performed; furthermore, alignment of the head module (11) to the carriage (10) can also be easily made.

Further, on each of the flexible wiring boards, of the four areas in the approximate shape of a right isosceles triangle partitioned with the bending line of the part that has been bent at a right angle, and the line that crosses at a right angle with saidbending line, the double-sided tapes respectively in the shape of an approximate right isosceles triangle will remain in a pair of areas in the longitudinal direction; thereby, each adhesive tape will adhere to the adhesive face on the flexible wiring board. This utilizes the characteristic that the adhesion between the double-sided tape and the flexible wiring board is stronger than the adhesion between two double-sided tapes. Furthermore, since the double-sided tape is provided so as not to cover the bending line at the bent part, when each flexible wiring board is bent at a right angle, the bending line is precisely formed.

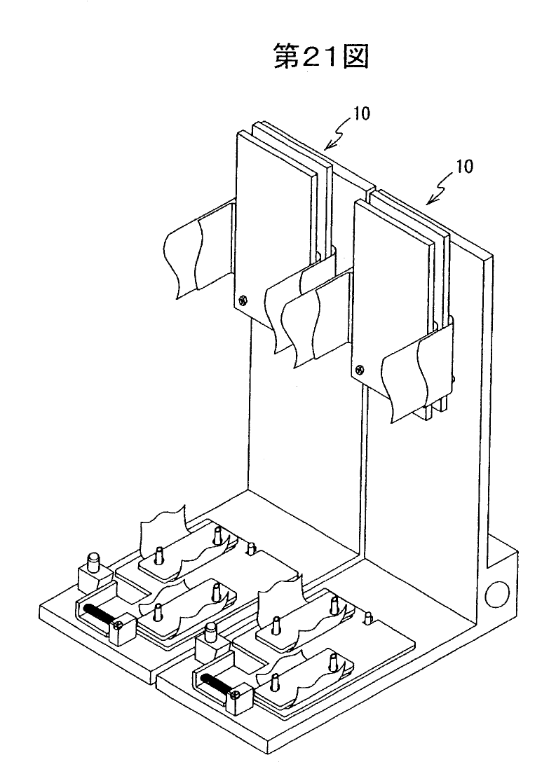

Incidentally, the present invention is not limited to the aforementioned form of application. Different variations can be made. A variation example of the present invention will be explained in reference to FIG. 20 and FIG. 21. FIG. 20 is an oblique view illustrating a variation example of the flexible wiring board; FIG. 21 is an oblique view illustrating a variation example of a carriage. With regard to the flexible wiring board, as illustrated in FIG. 20, if there is only one recording head, flexible wiring boards (115) and (116) with no curved parts provided may be used, and only the right angle and 180 degree bent parts can be provided. Also, the number of carriages provided does not have to be one. As illustrated in FIG. 21, multiple carriages may be connected in tandem. Further, in the aforementioned application form, an example was explained in which only one head module (11) is mounted on one carriage; however, needless to mention, a carriage with each of the head modules (11) for the four colors cyanogen, magenta, yellow, and black may be provided. Incidentally, the connection between the flexible wiring board and the ink jet recording head or the COB board is not limited to that made by soldering. Needless to mention, they may be bonded with a conductive adhesive or the like. Further, three or more COM boards may be fixed, superimposed with a certain space in between.

### POSSIBLE INDUSTRIAL USE

The invention is useful not only for printers but also for copiers, facsimile machines, and other image forming devices.

1. A recording head unit consisting of:
recording heads (13, 14) that records on a recording medium (P),
a base (12) on which said recording heads are fixed, and
a carriage (10) with the aforementioned base mounted on it, which moves in the main scan direction of recording relative to the aforementioned recording medium;
with the aforementioned carriage consisting of:
an axial support part (19) that axially supports the aforementioned base in such a manner that it can freely turn;
energizing means (20, 21) that energize the aforementioned base to turn in a certain direction, setting said axial support part as the fulcrum; and
an adjusting means (22) consisting of a pressing face (22a) that presses the aforementioned baseinto turn in a direction opposite to the aforementioned certain direction, which continuously adjusts the position of the aforementioned base within the adjustable range around the aforementioned axial support part; and
with the aforementioned base (12) consisting of an axial supported part (12b) that will be in contact with the aforementioned axial support part, along with a contact part (12c) that will be in contact with the pressing face of the aforementioned adjusting means in the aforementioned turning direction:

2. A recording head unit according to claim 1, wherein
the aforementioned adjusting means (22) is comprised of a wedge (22) [sic], which is screwed to the aforementioned carriage (10) with a screw (23); and
said wedge has, as the aforementioned pressing face, an inclined face (22a) provided, which presses the aforementioned base (12) to turn in a direction opposite to the aforementioned certain direction by moving forward and backward relative to the aforementioned carriage by means of the screwing operation of the aforementioned screw.

3. A recording head unit according to claim 2, wherein
the aforementioned base (12) is formed by pressing a metal plate;
the aforementioned base has a contact part (12c) that will be in contact with the inclined face (22a) of the aforementioned wedge (22); and
said contact part is an edge (12c) formed into the shape of an arc by the aforementioned pressing process.

4. A method to adjust the aforementioned recording head relative to the aforementioned carriage on a recording head unit consisting ofrecording heads (13, 14) that record on a recording medium (P),a base (12) on which said recording heads are fixed, anda carriage (10) with the aforementioned base mounted on it, which moves in the main scan direction of recording relative to the aforementioned recording medium; with the aforementioned carriage consisting ofan axial support part (19) that axially supports the aforementioned base in such a manner that it can freely turn,energizing means (20, 21) that energize the aforementioned base to turn to a certain direction, setting said axial support part as the fulcrum, andan adjusting means consisting of a pressing face (22a) that presses the aforementioned base to turn in a direction opposite to the aforementioned certain direction, which continuously adjusts the position of the aforementioned base within the adjustable range around the aforementioned axial support part; andwith the aforementioned base (12) consisting of an axial supported part (12b) that will be in contact with the aforementioned axial support part, along with a contact part (12c) that will be in contact with the pressing face of the aforementioned adjusting means in the aforementioned turning direction; wherein:
the method consists of a step of adjusting the position of the aforementioned base relative to the aforementioned carriage by adjusting the position of the aforementioned pressing face in the aforementioned turning direction by manipulating the aforementioned adjusting means.
